(19) United States
(12) Patent Application Publication
(10) Pub. No.: US 2004/0254672 A1
(43) Pub. Date: Dec. 16, 2004

(54) Method for manufacturing a core insert for a mold

(76) Inventor: Ga-Lane Chen, Fremont, CA (US)

Correspondence Address: WEI TE CHUNG, FOXCONN INTERNATIONAL, INC., 1650 MEMOREX DRIVE, SANTA CLARA, CA, 95050, US

(21) Appl. No.: 10/858,746

(22) Filed: Jun. 1, 2004

(30) Foreign Application Priority Data
May 30, 2003 (TW) 92114850

(51) Int. Cl. G06F 19/00

(52) U.S. Cl. 700/160; 700/117; 219/121.12

(57) ABSTRACT

A method for manufacturing a core insert for a molding system uses an electron beam emitter (10) to machine a core insert preform (30). The method includes: mathematically calculating a most similar combined curved surface to that of a desired surface of the core insert preform; measuring an initial surface of the core insert preform; comparing data of the initial surface to data of the calculated combined curved surface, and obtaining a matrix of surface error; storing the matrix of surface error in a computer, wherein the matrix of surface error defines a surplus area of the initial surface that needs to be removed; driving and controlling an electron gun (101) by way of the computer; and using the electron gun to machine the core insert preform according to the matrix of surface error. The method does not need repeated measuring of the machined surface, and thus reduces the manufacturing time.

### BACKGROUND OF THE INVENTION

1. Field of the Invention

The present invention relates to a method for manufacturing a core insert for a molding system such as a system for making lenses for cameras.

2. Related Art

Recently, mobile phones with cameras have been rapidly gaining in popularity. An aspheric lens of a mobile phone camera needs to be as thin as about 1 mm. The precision of the lens surface needs to be about ±1 μm. Because the aspheric lens has only one axis of symmetry and has different curvatures, machining of the aspheric lens is difficult. Traditionally, a lens preform is formed by molding, and is then mechanically finished. Various of such conventional methods take a long time and are relatively imprecise. For example, a surface of the preform to be machined may need repeated measuring. It is difficult and troublesome to obtain a lens having the desired precision.

Therefore, a method for manufacturing a core insert which needs only a short machining time and which has high machining precision is desired.

### SUMMARY OF THE INVENTION

An object of the present invention is to provide a method for precisely and readily manufacturing a core insert for a mold such as a mold used for making lenses for cameras.

To achieve the above object, a method of the present invention for manufacturing a core insert includes the steps of: mathematically calculating a most similar combined curved surface to that of a desired surface of the core insert; measuring an initial surface of a core insert preform; comparing data of the initial surface to data of the calculated combined curved surface, and obtaining a matrix of surface error, wherein the matrix of surface error defines a surplus area of the initial surface that needs to be removed; storing the matrix of surface error in a memory of a computer; driving and controlling an electron gun by way of the computer; and using the electron gun to machine the core insert preform according to the matrix of surface error. The manufacturing method does not need repeated measuring of the machined surface, and thus reduces the manufacturing time.

Other objects, features and advantages of the present invention will become more apparent after reading the following detailed description of a preferred embodiment thereof in conjunction with the accompanying drawing.

### BRIEF DESCRIPTION OF THE DRAWING

FIG. 1 is a schematic, cross-sectional view of machining equipment used to carry out the method of the present invention.

### DETAILED DESCRIPTION OF THE INVENTION

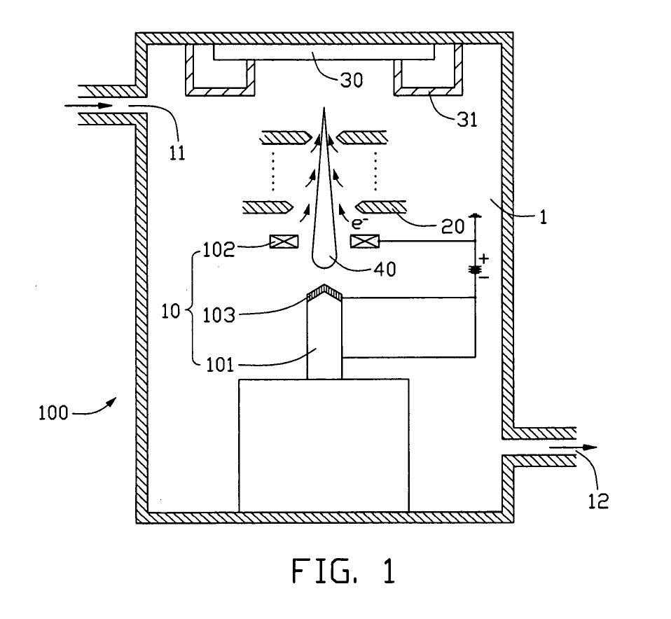

Referring to FIG. 1, machining equipment used for the present invention comprises an electron beam machine 100. The electron beam machine 100 comprises a vacuum chamber 1, an electron beam emitter 10, and a focus accelerating device 20. The vacuum chamber 1 has a gas inlet 11 in a left wall thereof, a gas outlet 12 in a right wall thereof, and two clamps 31 on a top wall thereof. The gas inlet 11 can transfer inert gas into the vacuum chamber 1.

A core insert manufactured according to the present invention is used for molding of aspheric lenses for cameras of mobile phones. The preferred material for the core insert is tungsten carbide (WC). WC has a high rigidity and a high melting point, and is able to bear high mechanical impact. In order to give the core insert a long working lifetime, the WC can have a coating of DLC (diamond-like carbon) film deposited thereon after machining thereof. The DLC film is preferably 10-30 nm thick. The DLC can be lubricated so that each formed aspheric lens is easily taken out from the core insert during manufacturing.

The electron beam emitter 10 comprises an electron gun 101, two anodes 102, and a cathode 103. The cathode 103 is made of zirconium_oxide (ZrO₂) or tungsten oxide (WO₃).

Detailed initial steps of the present invention are: mathematically calculating a most similar combined curved surface to that of a desired surface of the core insert; finishing a core insert preform 30 to a curved surface near to that of the desired surface using a conventional mechanical method; measuring the finished surface using a laser interferometer; comparing data of the finished surface to data of the calculated combined curved surface, and obtaining a matrix of surface error; and storing the matrix of surface error in a memory of a computer. The matrix of surface error defines a surplus area of the finished surface that needs to be removed.

Detailed subsequent steps of the present invention are: fixing the finished core insert preform 30 in the vacuum chamber 1; evacuating the vacuum chamber 1 until the pressure is lower than 5×10⁻³ pascal (Pa); connecting the electron beam emitter 10 to the computer; driving the electron gun 101, and controlling operation of the electron gun 101 by way of the computer; exciting the cathode 103 so that it emits an electron beam 40 having an intensity in the range from 1×10⁻¹²˜5×10 ⁻⁸ amperes (A); adjusting the focus accelerating device 20 in order to focus and accelerate the electron beam 40 to have a target range of 1-4 nm, the accelerating voltage being 5×10⁴ volts (V); and the electron beam 40 bombarding the finished surface so that the surplus area thereof melts and evaporates. It is to be understood that the smaller the target range, the more precise the machining by the electron beam 40 is. In order to obtain the desired surface, the computer can automatically control the direction and intensity of the electron beam 40 and the duration of machining according to the matrix of surface error.

In the method of the present invention, the core insert preform 30 can be machined in an inert gas environment if desired. The inert gas can prevent the core insert preform 30 from being oxidized. The inert gas may for example be argon (Ar) gas. Before the core insert preform 30 is machined, the gas inlet 11 and the gas outlet 12 are opened, and the inert gas is introduced into the vacuum chamber 1. Then the core insert preform 30 is machined by the electron beam 40 under a constant flux of the inert gas. After the machining is completed, the inert gas continues to be introduced into the vacuum chamber 1 until the core insert preform 30 is cooled. This method can prevent the core insert preform 30 from being oxidized.

Unlike conventional methods, the manufacturing method of the present invention does not need repeated measuring of the machined surface, and thus reduces the manufacturing time.

It is believed that the present invention and its advantages will be understood from the foregoing description and it will be apparent that various changes may be made thereto without departing from the spirit and scope of the invention or sacrificing all of its material advantages, the examples hereinbefore described merely being preferred or exemplary embodiments of the invention.

I claim:

1. A method for manufacturing a core insert, comprising the steps of:
(1) mathematically calculating a most similar combined curved surface to that of a desired surface of the core insert;
(2) measuring an initial surface of a core insert preform;
(3) comparing data of the initial surface to data of the calculated combined curved surface, and obtaining a matrix of surface error, wherein the matrix of surface error defines a surplus area of the initial surface that needs to be removed;
(4) storing the matrix of surface error in a computer memory;
(5) driving and controlling an electron beam emitter to emit an electron beam; and
(6) using the electron beam to machine the core insert preform according to the matrix of the surface error.

2. The method of claim 1, wherein the core insert is for molding of a camera lens.

3. The method of claim 1, wherein the initial surface is finished near to the desired surface by a conventional mechanical method before the measuring step is performed.

4. The method of claim 1, wherein the electron beam machining of the core insert preform is performed in a vacuum.

5. The method of claim 1, wherein the electron beam is focused and accelerated by a focus accelerating device.

6. The method of claim 1, wherein the electron beam machining of the core insert preform is performed in an inert gas environment.

7. The method of claim 6, wherein the inert gas is argon gas.

8. The method of claim 1, wherein the electron beam emitter comprises an electron gun, an anode and a cathode.

9. The method of claim 1, further comprising the step of coating the core insert with a diamond-like carbon film after the machining.

10. The method of claim 9, wherein a thickness of the diamond-like carbon film is in the range from 10˜30 nm.

11. The method of claim 4, wherein a pressure during the electron beam machining is lower than 5×10⁻³ pascal.

12. The method of claim 5, wherein the accelerating voltage of the focus accelerating device is approximately 5×10⁻⁴ volts.

13. The method of claim 1, wherein an intensity of the electron beam is in the range from 1×10⁻¹²˜5×10⁻⁸ amperes.
